(19) United States
(12) Patent Application Publication
(10) Pub. No.: US 2026/0144226 A1
(43) Pub. Date: May 28, 2026

(54) LIVING BODY TRANSPORTATION DEVICE

(71) Applicant: AISIN CORPORATION, Kariya (JP)

(72) Inventors: Masashi NOBUTOKI, Kariya-shi (JP); Shintaro SUZUKI, Kariya-shi (JP); Keisuke MISHIMA, Kariya-shi (JP); Wataru TAKAYANAGI, Kariya-shi (JP)

(73) Assignee: AISIN CORPORATION, Kariya (JP)

(21) Appl. No.: 19/396,920

(22) Filed: Nov. 21, 2025

(30) Foreign Application Priority Data
Nov. 28, 2024 (JP) 2024-207300

(51) Int. Cl. A01K 1/02

(52) U.S. Cl. CPC A01K 1/0272; A01K 1/0245

(57) ABSTRACT

A living body transportation device includes a top plate member to and from which a housing that can house a living body to be transported in a state of being in a movable body is attachable and detachable, and a pendulum unit including a pendulum main body portion that supports the top plate member and performs a pendulum motion together with the top plate member so as to suppress an inertial force acting on the living body during a moving motion accompanying at least one of an acceleration and deceleration motion and a turning motion with respect to a traveling direction of the movable body, a main body base portion that supports the pendulum main body portion, and a main body fixing portion that is formed on the main body base portion and enables the main body base portion to be attachable and detachable to and from the movable body.

### CROSS REFERENCE TO RELATED APPLICATIONS

This application is based on and claims priority under 35 U.S.C. § 119 to Japanese Patent Application No. 2024-207300, filed on Nov. 28, 2024, the entire content of which is incorporated herein by reference.

### TECHNICAL FIELD

Embodiments of the present disclosure relate to a living body transportation device.

### BACKGROUND DISCUSSION

Conventionally, there is a case where it is desired to move (transport) a pet (a living body) such as a dog or a cat in a movable body, for example, a vehicle (an automobile or the like). In such a case, it is known that, for example, the living body is housed in a dedicated housing (also referred to as a crate) or the like and under such a state, the housing is fixed on a seat or a trunk, so that the pet or the like can be safely transported. In addition, in a case where the pet or the like is loaded on the movable body and transported as described above, shaking that may occur at the time of acceleration and deceleration or turning of the movable body (the automobile) may put a burden (stress) on the pet. Therefore, consideration for reducing the burden on the pet may be required. In such a case, for example, gentle driving (for example, driving at low speed) in which extreme acceleration and deceleration, turning at high speed, or the like is not performed may be required, or a medicine or the like for alleviating stress may be prescribed to the pet. In addition, there has been proposed a technique of alleviating stress at the time of transportation by applying physical stimulation such as acupuncture and moxibustion to a part of a body surface of a pet before transportation or the like (for example, see Japanese Patent Application Laid-Open No. 10-315866 and Japanese Patent No. 6589867).

However, gentle driving that reduces the burden on the pet (the living body) by gentle driving may cause a decrease in transportation efficiency or may be a burden on a driver. In addition, there is a case where it is difficult to adopt the prescription of the medicine and the use of the physical stimulation described above because preparation and specialized knowledge therefor are required.

A need thus exists for a living body transportation device which is not susceptible to the drawback mentioned above.

### SUMMARY

A living body transportation device includes a top plate member to and from which a housing that can house a living body to be transported in a state of being in a movable body is attachable and detachable, and a pendulum unit that includes a pendulum main body portion that supports the top plate member and performs a pendulum motion together with the top plate member so as to suppress an inertial force acting on the living body during a moving motion accompanying at least one of an acceleration and deceleration motion and a turning motion with respect to a traveling direction of the movable body, a main body base portion that supports the pendulum main body portion, and a main body fixing portion that is formed on the main body base portion and enables the main body base portion to be attachable and detachable to and from the movable body.

The foregoing and additional features and characteristics of this disclosure will become more apparent from the following detailed description considered with the reference to the accompanying drawings, wherein:

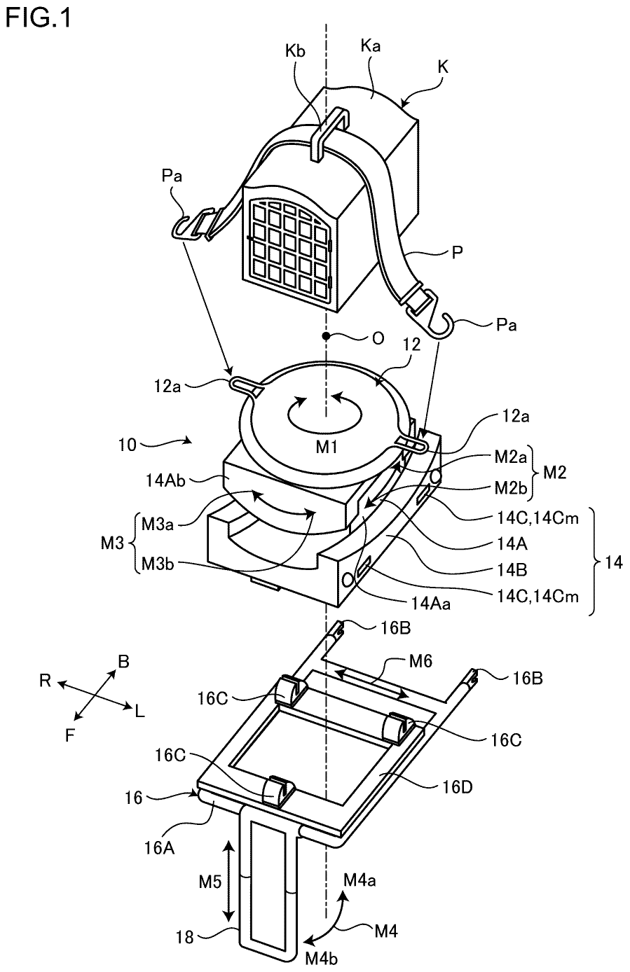

FIG. 1 is an exemplary schematic exploded perspective view illustrating a configuration of a living body transportation device according to an embodiment;

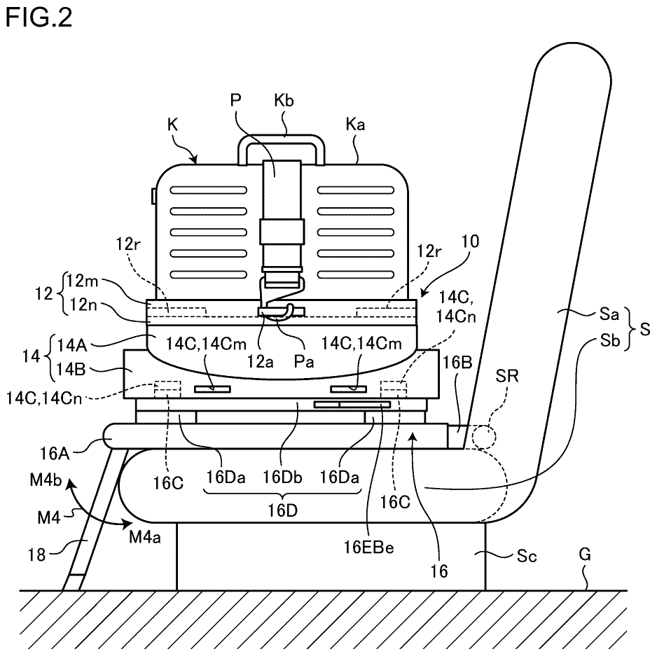

FIG. 2 is an exemplary schematic side view illustrating a state where the living body transportation device according to the embodiment is fixed on a seat of a movable body (a vehicle);

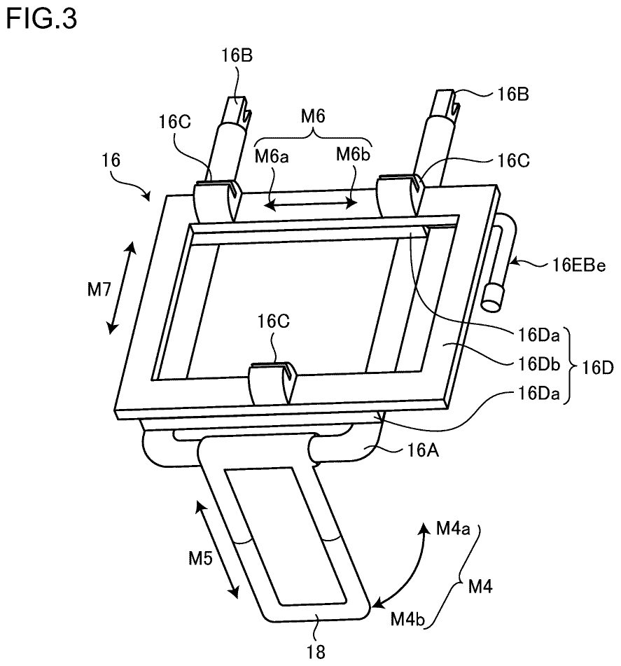

FIG. 3 is an exemplary schematic perspective view illustrating a seat fixing body constituting the living body transportation device according to the embodiment;

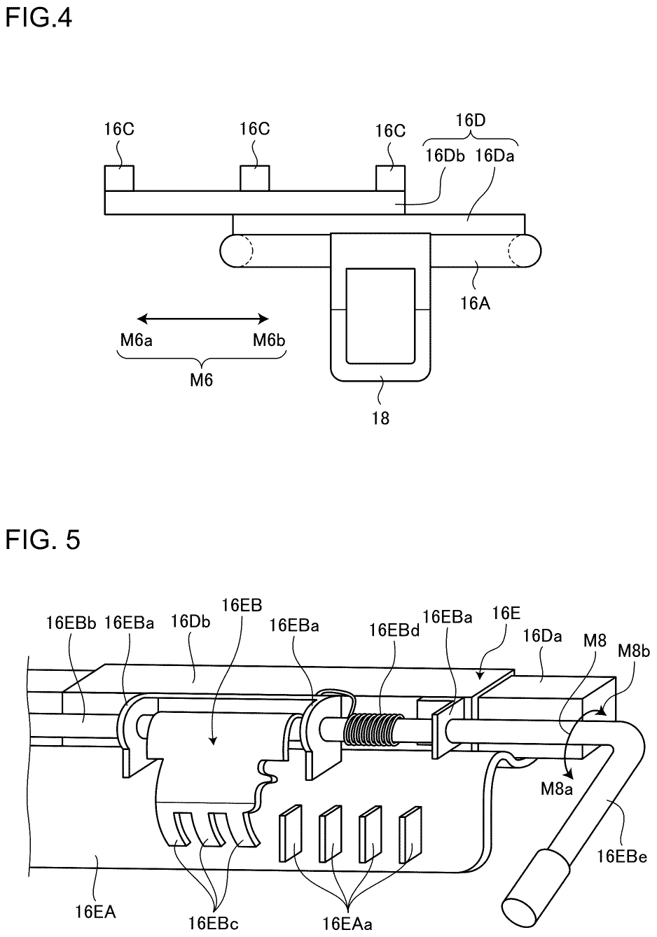

FIG. 4 is an exemplary schematic side view illustrating the seat fixing body constituting the living body transportation device according to the embodiment; and

FIG. 5 is an exemplary schematic perspective view illustrating a lock structure in an adjustment mechanism of the seat fixing body constituting the living body transportation device according to the embodiment.

### DETAILED DESCRIPTION

Hereinafter, exemplary embodiments of the present disclosure are disclosed. The configurations of the embodiments described below, and the actions, results, and effects brought by the configurations are examples. The present disclosure can be implemented by configurations other than those disclosed in the following embodiments, and at least one of various effects based on the basic configuration and derivative effects can be obtained.

FIG. 1 is an exemplary schematic exploded perspective view illustrating a configuration of a living body transportation device 10 according to an embodiment. FIG. 2 is an exemplary schematic side view illustrating a state where the living body transportation device 10 according to the embodiment is fixed on a seat S of a movable body (a vehicle). Note that a case where the living body transportation device 10 illustrated in FIG. 1 is fixed on the seat S (see FIG. 2) of a vehicle (for example, an automobile) (not illustrated) as an example of a movable body will be described. Furthermore, for convenience, the forward direction in a case where the movable body moves is indicated by an arrow F, the backward direction is indicated by an arrow B, the right vehicle width direction (the right turning direction) is indicated by an arrow R, and the left vehicle width direction (the left turning direction) is indicated by an arrow L.

The living body transportation device 10 of the present embodiment is a device capable of reducing stress applied to a living body caused by an inertial force (a centrifugal force at the time of turning) that can be generated along with acceleration and deceleration or turning of a movable body when a pet (a living body) such as a cat or a dog is loaded on the movable body and transported in a state of being housed in a housing K (also referred to as a crate).

The basic configuration of the living body transportation device 10 includes a top plate member 12 and a pendulum unit 14.

The top plate member 12 can detachably fix the housing K that can house a living body. The top plate member 12 can be, for example, a flat plate-like member with a disk shape. The top plate member 12 is only required to have strength capable of supporting the weight of the housing K in a state where the living body is housed, and can be made of, for example, a resin material, a metal material, or the like. Note that the top plate member 12 is desirably made of a resin material or the like from the viewpoint of weight reduction. The materials of the pendulum unit 14, a seat fixing body 16 to be described later, and the like similarly constituting the living body transportation device 10 are desirably selected by appropriately using a resin material or a metal material so as to be able to reduce the weight while ensuring the required strength.

The top plate member 12 includes a belt fixing portion 12a used for fixing the housing K at a part of the top plate member 12, for example, an outer edge portion of a disk. In the case of FIG. 1, an example in which two belt fixing portions 12a are formed at opposing positions (positions separated by 180°) is illustrated. The belt fixing portion 12a is, for example, a ring-shaped member, and can be engaged with a hook Pa provided at the distal end of a fixing belt P inserted through a handle Kb (a portion to be gripped in a case where only the housing K is carried) formed on a ceiling surface Ka or the like of the housing K. The fixing belt P is a belt whose length can be adjusted, and by adjusting the length in a state where the hook Pa is hooked on each of the belt fixing portions 12a, the housing K can be fixed to the top plate member 12. Note that, as long as the housing K can be fixed to the top plate member 12, the fixing mode thereof can be appropriately selected. For example, the number of the fixing belts P may be two or more. Furthermore, instead of the fixing belt P, an engagement mechanism (for example, a snap latch or the like) may be used.

The top plate member 12 can include a rotation mechanism (a turning mechanism) that can adjust the fixing direction of the housing K with respect to the traveling direction of the movable body as indicated by arrows M1 in a state of being attached on the upper surface of the pendulum unit 14. For example, as illustrated in FIG. 2, the rotation mechanism of the top plate member 12 can be configured to have a two-layer structure of an upper member 12m and a lower member 12n, and dispose a rolling element 12r with a rotation lock mechanism between the upper member 12m and the lower member 12n. As a result, the upper member 12m can be turnably fixed at intervals of 90°, for example. As will be described later, this turning and fixing operation can contribute to simplification of work when the housing K is mounted and fixed on the living body transportation device 10 (the top plate member 12) or is lowered from the living body transportation device 10 (the top plate member 12). Note that it is only required that the rotation mechanism can turn and fix (lock) at a predetermined position, and various mechanisms can be used. For example, the top plate member 12 may have a single-layer configuration, and a bearing with a rotation lock mechanism may be disposed at the central portion (the turning center) thereof to be rotatable (turnable).

The pendulum unit 14 includes a pendulum main body portion 14A, a main body base portion 14B, and a main body fixing portion 14C formed on the main body base portion 14B. Note that the main body fixing portion 14C includes a belt attachment portion 14Cm that is used when the living body transportation device 10 is fixed on a trunk or the like, and a fixing connector portion 14Cn that fixes the living body transportation device 10 on the seat S using the seat fixing body 16 as illustrated in FIG. 2, but only the belt attachment portion 14Cm is illustrated in FIG. 1.

The pendulum main body portion 14A supports the top plate member 12 on the upper portion thereof, and can perform the pendulum motion together with the top plate member 12 so as to suppress the inertial force acting on the living body housed in the housing K during the moving motion accompanying at least one of the acceleration and deceleration motion and the turning motion with respect to the traveling direction of the movable body. The pendulum main body portion 14A can be configured by a known pendulum mechanism that can perform the pendulum motion. The pendulum main body portion 14A can be configured by, for example, a combination of a first pendulum mechanism 14Aa and a second pendulum mechanism 14Ab. In FIG. 1, the first pendulum mechanism 14Aa is a mechanism that swings in a swing direction (a direction of an arrow M2: forward swing of the movable body is indicated by an arrow M2b, and backward swing of the movable body is indicated by an arrow M2a) corresponding to the traveling direction (directions of the arrows F and B) of the movable body with a virtual point O defined above the pendulum main body portion 14A as a fulcrum. In addition, the second pendulum mechanism 14Ab is a mechanism that swings in a direction (directions of the arrows L and R) orthogonal to the traveling direction of the movable body with the virtual point O as a fulcrum, that is, a swing direction corresponding to the vehicle width direction of the movable body, which is indicated by an arrow M3 (right swing of the movable body is indicated by an arrow M3a, and left swing of the movable body is indicated by an arrow M3b).

The pendulum main body portion 14A (the first pendulum mechanism 14Aa and the second pendulum mechanism 14Ab) may operate passively or actively as long as the pendulum main body portion 14A can perform the pendulum motion. In a case where the pendulum main body portion 14A is configured to passively operate, for example, a structure using a roller that rolls on a curved sliding surface or a structure using sliding between curved sliding surfaces can be used, and the swing motion can be performed based on the generated inertial force. In addition, in a case where the pendulum main body portion 14A is configured to actively operate, for example, the generated inertial force and the behavior of the movable body that has caused the inertial force are detected by a sensor or the like, and an actuator such as a motor is driven on the basis of the detection results, so that the swing motion can be performed.

Note that the pendulum main body portion 14A may include a balance adjustment mechanism that performs balance adjustment in a case where the housing K is fixed to the top plate member 12, separately from the swing motion. For example, in a state where no inertial force acts on the pendulum main body portion 14A (for example, a case where the movable body is stopped on a flat road surface, and the like), the pendulum main body portion 14A may swing (incline) depending on the fixed position (the position of the center of gravity) of the housing K on the top plate member 12. In such a case, for example, the fixed position and the position of the center of gravity of the housing K may be detected by a sensor or the like, and an actuator (a motor or the like) for posture adjustment may be driven on the basis of the detection results to adjust the posture of the pendulum main body portion 14A to be substantially parallel to the movable body (the seat S). That is, the pendulum main body portion 14A can be configured to perform the swing motion based on the inertial force generated during movement with reference to a state where the housing K (the living body) is in a posture substantially parallel to the movable body (the seat S). As a result, it is possible to contribute to improvement of mounting stability when the living body gets in the movable body using the living body transportation device 10. In addition, it is possible to contribute to reducing the stress on the living body caused by the inclination of the posture when the living body gets in the movable body or the like.

The main body base portion 14B is a component that supports the pendulum main body portion 14A, and for example, swingably supports the first pendulum mechanism 14Aa via a guide mechanism, a rail mechanism, and the like. The main body base portion 14B includes the main body fixing portion 14C that can be fixed to the movable body in a state of supporting the pendulum main body portion 14A. The living body transportation device 10 of the present embodiment can take a direct fixing mode in which the main body base portion 14B (the pendulum unit 14) is directly fixed to the movable body, and an indirect fixing mode in which fixing is performed using a dedicated metal fitting (an anchor portion SR to be described later) mounted on the seat S or a movable body frame that fixes the seat S.

In the case of the direct fixing mode, for example, the main body base portion 14B is directly fixed on the floor of a trunk space or the like or in a vehicle interior using a belt or the like. In the case of the direct fixing mode, for example, one end of the belt is attached to the belt attachment portion 14Cm as the main body fixing portion 14C formed on the main body base portion 14B, and the other end is attached and fixed to a fixing metal fitting or the like provided on the floor of the trunk space or in the vehicle interior, so that the living body transportation device 10 can function.

On the other hand, in the case of the indirect fixing mode, as illustrated in FIG. 2, first, the seat fixing body 16 is connected to the anchor portion SR as the metal fitting mounted on the seat S of the movable body or the movable body frame that fixes the seat S, and then is fixed to the seat S. The anchor portion SR is a component provided at, for example, a connecting portion of a seat back portion Sa and a seat surface portion Sb of the seat S. The anchor portion SR may be provided as a dedicated component in the seat S. In addition, for example, in the case of a vehicle equipped with the international standard ISOFIX for fixing a child seat to the seat S, the ISOFIX anchor may be used as the anchor portion SR that fixes the main body base portion 14B (the living body transportation device 10) to the seat S.

As illustrated in FIG. 1, the seat fixing body 16 includes a frame portion 16A, a connector portion 16B, a unit fixing portion 16C, and a slide portion 16D (an adjustment mechanism). The frame portion 16A is made of, for example, a pipe-shaped resin material or metal material, and includes the connector portion 16B with, for example, an alligator-jaw structure corresponding to the formation position (the formation interval) of the anchor portion SR (the ISOFIX anchor) at a back end portion (on the back side when installed in the seat S). In the case of FIG. 1, two connector portions 16B are formed in accordance with the number of the anchor portions SR formed. For example, the connector portion 16B is pressed against the anchor portion SR to complete the coupled and fixed state, and the connector portion 16B and the anchor portion SR are integrated. As a result, the seat S of the movable body or the movable body frame that fixes the seat S is substantially integrated with the seat fixing body 16. That is, the seat fixing body 16 is firmly fixed to the movable body. For example, in the connector portion 16B and the anchor portion SR in the coupled and fixed state, by operating a release switch (not illustrated) or the like, the alligator-jaw of the connector portion 16B is opened, and the coupling between the connector portion 16B and the anchor portion SR is released. As a result, the seat fixing body 16 can be removed from the seat S (the movable body).

A leg portion 18 for stabilizing a fixed posture when the seat fixing body 16 is installed (fixed) to the seat S is provided at a front end portion of the frame portion 16A (on the side opposite to the side on which the connector portion 16B is formed). The leg portion 18 is rotatable in a direction of an arrow M4 with respect to the frame portion 16A. In a case where the seat fixing body 16 is removed from the seat S, in a case where the seat fixing body 16 is transported, or the like, for example, the leg portion 18 is rotated in a direction of an arrow M4a, and is moved to (brought into contact with) the lower surface side of the frame portion 16A, so that the frame portion 16A can be made compact and easy to handle. Furthermore, in a case where the seat fixing body 16 is fixed to the seat S, the leg portion 18 is rotated in a direction of an arrow M4b. As a result, as illustrated in FIG. 2, the leg portion 18 can contact a vehicle interior floor G of the movable body, and for example, it is possible to prevent the frame portion 16A (the living body transportation device 10) from falling forward (diving) at the time of deceleration or the like of the movable body. Note that the leg portion 18 can expand and contract in a direction of an arrow M5. By making the leg portion 18 expandable and contractible, it is possible to contribute to compactness when the leg portion 18 rotates in the direction of the arrow M4a, and to contribute to improvement in fixation and stabilization of the frame portion 16A (the living body transportation device 10) by adjustment of the degree of tension when the leg portion 18 rotates in the direction of the arrow M4b.

The unit fixing portion 16C is a member for connecting and fixing the main body base portion 14B (the pendulum unit 14) and the seat fixing body 16 on the upper surface side of the frame portion 16A, and is formed at, for example, three positions. For example, the alligator-jaw structure can be used for the unit fixing portion 16C similarly to the connector portion 16B. As illustrated in FIG. 2, by pressing the fixing connector portion 14Cn formed on the lower surface of the main body base portion 14B against the unit fixing portion 16C, the coupled and fixed state is completed, and the fixing connector portion 14Cn and the unit fixing portion 16C are integrated. As a result, the seat fixing body 16 fixed to the seat S of the movable body or the movable body frame that fixes the seat S, and the main body base portion 14B (the pendulum unit 14) are substantially integrated. That is, the pendulum unit 14 is firmly fixed to the movable body. In the fixing connector portion 14Cn and the unit fixing portion 16C in the coupled and fixed state, for example, by operating a release switch (not illustrated) or the like, the alligator-jaw of the unit fixing portion 16C is opened, the coupling between the fixing connector portion 14Cn and the unit fixing portion 16C is released, and the pendulum unit 14 can be removed from the seat fixing body 16 (the seat S (the movable body)).

Note that FIG. 1 illustrates an example in which three unit fixing portions 16C are arranged in a substantially triangular shape. However, it is only required that the fixing and connection between the seat fixing body 16 and the main body base portion 14B (the pendulum unit 14) can ensure sufficient strength capable of supporting and fixing the pendulum unit 14 including the housing K in a state where the living body is housed, and the number, arrangement form, and connection method of the unit fixing portions 16C can be appropriately changed.

The slide portion 16D is a mechanism that enables the main body base portion 14B (the pendulum unit 14) connected and fixed to move, with respect to the frame portion 16A, in a direction of an arrow M6, that is, in a direction (directions of the arrows L and R in FIG. 1) orthogonal to the traveling direction of the movable body. In the arrow M6, the right side of the movable body is indicated by an arrow M6a, and the left side is indicated by an arrow M6b. As described above, for example, in a case where the ISOFIX anchor provided in the rear seat of a four-door vehicle is used as the anchor portion SR to which the connector portion 16B of the seat fixing body 16 is connected, the ISOFIX anchor is provided in a seat of the rear seat close to the door, in many cases. For example, in a case where the rear seat includes three seats arranged side by side, the ISOFIX anchor is provided in the left rear seat or the right rear seat in many cases. Although details will be described later, in a case where the living body transportation device 10 is fixed using, for example, the ISOFIX anchor provided in the left rear seat, it is possible to easily perform the work of getting on and off the housing K with respect to the living body transportation device 10. On the other hand, in a case where the pendulum unit 14 swings in the direction of the arrow M3b illustrated in FIG. 1 while the movable body is traveling, the pendulum unit 14 may come into contact with the left rear door. As a result, sufficient swing motion (operation of counteracting centrifugal force to be described later) may be hindered.

Therefore, the slide portion 16D is a mechanism that is slidable between a first fixed position suitable for the work of attaching and detaching the pendulum unit 14 and the housing K and a second fixed position at which the pendulum unit 14 does not come into contact with surrounding components (for example, a door and the like) when actually performing the swing motion. The first fixed position is, for example, a position at which work can be easily performed when the pendulum unit 14 is attached to and detached from the seat fixing body 16 from the left rear door (the seat entrance side), or when the housing K is attached to and detached from the pendulum unit 14 (the top plate member 12) attached to the seat fixing body 16 from the left rear door. That is, the first fixed position is close to the left rear door. In addition, the second fixed position is a position that is closer to the center side (the right rear seat side) of the rear seat than the first fixed position and at which interference (contact) with the door or the like can be avoided.

FIGS. 3 to 5 are explanatory views illustrating the detailed structure of the slide portion 16D as the adjustment mechanism of the seat fixing body 16. FIG. 3 is an exemplary schematic perspective view illustrating the slide portion 16D of the seat fixing body 16. In addition, FIG. 4 is an exemplary schematic side view illustrating the slide portion 16D. FIG. 5 is an exemplary schematic perspective view illustrating a slide lock structure in the slide portion 16D of the seat fixing body 16.

The slide portion 16D can implement a sliding operation by, for example, a combination of a slide rail 16Da and a carrier 16Db. In the case of the present embodiment, for example, two slide rails 16Da are fixed on the upper surface of the frame portion 16A so as to extend in the direction of the arrow M6 (the width direction of the movable body). The two slide rails 16Da are arranged at a predetermined interval in a direction of an arrow M7 as illustrated in FIG. 3. For example, a rectangular plate-like carrier 16Db, which has a hollow shape, is connected to the two slide rails 16Da so as to extend between the two slide rails 16Da. The unit fixing portions 16C described above are fixed on the upper surface of the carrier 16Db in the arrangement pattern corresponding to the arrangement pattern of the fixing connector portions 14Cn formed on the back surface of the main body base portion 14B.

In a case where the seat fixing body 16 is fixed to, for example, the left rear seat of the movable body, the carrier 16Db is at the position illustrated in FIG. 3 with respect to the slide rail 16Da. That is, the carrier 16Db is at the first fixed position. Since the carrier 16Db is at the first fixed position, in a case where the pendulum unit 14 is attached to and detached from the seat fixing body 16, it is possible to easily take access from the left rear door, and the work of attaching and detaching the pendulum unit 14 can be easily performed. Similarly, in a case where the pendulum unit 14 having the top plate member 12 fixed thereto is already attached to the seat fixing body 16, when the housing K is attached and detached, it is possible to easily take access from the left rear door, and the work of attaching and detaching the housing K can be easily performed.

In a case where the housing K has been fixed to the pendulum unit 14 with respect to the seat fixing body 16, when the movable body is in a movable state, the carrier 16Db moves in the direction of the arrow M6a with respect to the slide rail 16Da, and in a state of moving to the position illustrated in FIG. 4, that is, the second fixed position, the slide position is fixed. Note that FIG. 4 does not illustrate the pendulum unit 14 and the housing K. As described above, the second fixed position is a position at which the pendulum unit 14 does not come into contact with surrounding components (for example, the left rear door and the like) even if the pendulum unit 14 performs the pendulum motion in the direction of the arrow M3 (see FIG. 1). Therefore, it is possible to satisfactorily perform the operation of counteracting the inertial force (the centrifugal force) by the swing motion of the pendulum unit 14.

As described above, in the case of performing the work of attaching and detaching the pendulum unit 14 to and from the seat fixing body 16 or in the case of performing the work of attaching and detaching the housing K to and from the pendulum unit 14, it is desirable that the carrier 16Db is slid in the direction of the arrow M6b with respect to the slide rail 16Da to be fixed at the first fixed position. Similarly, in a case where the pendulum unit 14 performs the swing motion (in a case where the movable body is moving), it is desirable that the carrier 16Db is slid in the direction of the arrow M6a with respect to the slide rail 16Da to be fixed at the second fixed position. The slide portion 16D thus includes a slide lock mechanism 16E illustrated in FIG. 5.

The slide lock mechanism 16E can include, for example, a lock plate 16EA fixed to the slide rail 16Da side and a lock operation body 16EB fixed to the carrier 16Db side. The lock plate 16EA includes a plurality of lock pieces 16EAa at positions corresponding to the first fixed position and the second fixed position at which the carrier 16Db is stopped and positionally fixed after sliding. On the other hand, the lock operation body 16EB includes a bracket 16EBa, a shaft 16EBb, a lock operation plate 16EBc, a biasing member 16EBd, and the like. The bracket 16EBa is fixed to a part of the carrier 16Db. A plurality of the brackets 16EBa are provided to pivotally support the shaft 16EBb so as to be rotatable in a direction of an arrow M8. The shaft 16EBb is, for example, a cylindrical member with a substantially L-shape whose one end side is bent. Note that the portion bent in an L-shape functions as an operation handle 16EBe. The biasing member 16EBd is, for example, a torsion spring, and has one end side hooked (fixed) to the shaft 16EBb and the other side hooked (fixed) to, for example, the bracket 16EBa. The biasing member 16EBd constantly biases the shaft 16EBb so as to rotate in a direction of an arrow M8a.

In a case where the carrier 16Db is moved to the first fixed position or the second fixed position, the shaft 16EBb is rotated in an arrow M8b by the operation of the operation handle 16EBe against the biasing force of the biasing member 16EBd. As a result, the lock operation plate 16EBc can climb over the lock piece 16EAa. By releasing the operation handle 16EBe in a state where the lock operation plate 16EBc has climbed over the lock piece 16EAa formed at the first fixed position, for example, the shaft 16EBb rotates in the direction of the arrow M8a by the biasing force of the biasing member 16EBd. As a result, the lock operation plate 16EBc and the lock piece 16EAa can be meshed with each other. That is, the carrier 16Db can be fixed at the first fixed position. A case where the carrier 16Db is slid to and fixed at the second fixed position can also be implemented by a similar operation.

The slide lock mechanism 16E may have another structure as long as the carrier 16Db can be moved in the direction of the arrow M6 and locked at the first fixed position or the second fixed position. Furthermore, the number of positions at which the carrier 16Db is fixed is not limited to two, and for example, the lock piece 16EAa for the second fixed position may be provided at a plurality of positions so that the position of the carrier 16Db (the housing K) on the seat S can be appropriately selected.

Note that the slide direction of the slide lock mechanism 16E provided in the seat fixing body 16 with respect to the frame portion 16A during the swing operation of the living body transportation device 10 differs in the slide lock mechanism for the left rear seat and the slide lock mechanism for the right rear seat. Therefore, the seat fixing body 16 may be configured to be dedicated to the left rear seat or the right rear seat, or may be configured to be shared by the left rear seat and the right rear seat by appropriately adjusting the connecting position and the shape of the slide lock mechanism 16E (the carrier 16Db) with respect to the frame portion 16A.

The procedure of attaching and detaching the living body transportation device 10 configured as described above to and from the seat S of the movable body will be described with reference to FIGS. 1 to 5.

As described above, the living body transportation device 10 includes the top plate member 12 and the pendulum unit 14, and can be fixed on the seat S using the seat fixing body 16. That is, the three components can be stored and transported in a divided state.

In a case where the living body transportation device 10 is fixed on the seat S, first, only the seat fixing body 16 is brought into the seat S to be attached, and the connector portion 16B provided at the back end of the frame portion 16A of the seat fixing body 16 is pressed against the anchor portion SR provided in the seat S to be coupled and fixed thereto. Note that, in this case, the carrier 16Db of the seat fixing body 16 is fixed at the first fixed position on the door side (the entrance side). Furthermore, the leg portion 18 provided on the front end side of the frame portion 16A is raised in the direction of the arrow M4b. At this time, the leg portion 18 is adjusted to expand and contract in the direction of the arrow M5, and is disposed so as to strut against the vehicle interior floor G on which a base Sc of the seat S of the movable body is fixed, as illustrated in FIG. 2. That is, the adjustment is performed in a supporting manner that the frame portion 16A is substantially horizontally fixed on the seat S.

Subsequently, the pendulum unit 14 is brought into the seat S, and the fixing connector portion 14Cn of the pendulum unit 14 is pressed against the unit fixing portion 16C of the seat fixing body 16 to bring the fixing connector portion 14Cn and the unit fixing portion 16C into the coupled and fixed state. Furthermore, the top plate member 12 is brought to the seat S and fixed on the upper surface of the pendulum unit 14. In this state, mounting and fixation of the living body transportation device 10 on the seat S is completed.

As described above, the living body transportation device 10 can be mounted and fixed on the seat S by bringing the divided components into the seat S from the door (the entrance) of the seat S and assembling the components, so that the mounting work can be easily performed. Similarly, when the living body transportation device 10 is removed from the seat S, the components can be divided and taken out, so that the removal work can also be easily performed.

After the living body transportation device 10 is fixed on the seat S, the housing K that houses the living body (for example, a pet such as a dog or a cat) is placed on the top plate member 12 and fixed using the fixing belt P. Note that, as described above, the top plate member 12 is rotatable in the direction of the arrow M1. For this reason, the work of fixing the housing K to the top plate member 12 can be easily performed even in a case where the housing K is brought from any direction. Furthermore, after the housing K is fixed to the top plate member 12, by rotating and adjusting the top plate member 12 in the direction of the arrow M1, the housing K can be directed in a certain direction and fixed in posture at that position. For example, as illustrated in FIG. 2, by adjusting the fixed posture of the housing K, it is possible to adjust the living body housed in the housing K to face forward of the movable body, for example.

Subsequently, the carrier 16Db of the seat fixing body 16 is slid to the second fixed position at which the pendulum unit 14 does not come into contact with surrounding components when performing the pendulum motion, and is fixed at that position. In this state, the preparation for satisfactorily exerting the function of the living body transportation device 10 that alleviates or suppresses the stress applied to the living body even when the movable body starts to move is completed.

Next, a state of the operation of the living body transportation device 10 mounted on the seat S of the movable body will be described.

As described above, in a case where the living body such as a pet is in the movable body without using the living body transportation device 10, for example, when the movable body performs a braking operation while traveling forward, the living body receives a forward inertial force due to deceleration (acceleration) and is thrown forward. This state may be a stress for the living body.

On the other hand, in a case where the living body such as a pet is in the movable body using the living body transportation device 10, the inertial force due to deceleration (acceleration) also acts on the pendulum main body portion 14A of the living body transportation device 10 (the pendulum unit 14) fixed to the movable body. In this case, the first pendulum mechanism 14Aa moves (swings) the housing K forward (in the direction of the arrow M2b) together with the top plate member 12. As a result, it is possible to offset the influence (the inertial force) of deceleration (acceleration). That is, it is possible to alleviate or suppress the stress applied to the living body at the time of deceleration of the movable body.

When the movable body performs an acceleration operation while traveling forward, the living body receives a backward inertial force due to acceleration (acceleration) and is thrown backward. This state may also be a stress for the living body. In a case where the living body such as a pet is in the movable body using the living body transportation device 10, the inertial force due to acceleration (acceleration) also acts on the pendulum main body portion 14A of the living body transportation device 10 (the pendulum unit 14) fixed to the movable body. In this case, the first pendulum mechanism 14Aa moves (swings) the housing K backward (in the direction of the arrow M2a) together with the top plate member 12. As a result, it is possible to offset the influence (the inertial force) of acceleration (acceleration). That is, it is possible to alleviate or suppress the stress applied to the living body at the time of acceleration of the movable body, as in the case of the deceleration of the movable body.

In addition, in a case where the movable body turns while traveling forward (for example, in a case where the movable body turns left), the living body receives a centrifugal force (an inertial force) directed to turning outward (the direction of the arrow R in FIG. 1) by turning, and is thrown in a turning outward direction (the direction of the arrow R). This state may also be a stress for the living body. On the other hand, in a case where the living body such as a pet is in the movable body using the living body transportation device 10, the centrifugal force directed to turning outward (the direction of the arrow R) also acts on the pendulum main body portion 14A of the living body transportation device 10 (the pendulum unit 14) fixed to the movable body. In this case, the second pendulum mechanism 14Ab moves (swings) the housing K in the turning outward direction (in the direction of the arrow M3a) together with the top plate member 12. As a result, it is possible to offset the influence of the centrifugal force at the time of the left turn. That is, it is possible to alleviate or suppress the stress applied to the living body when the movable body turns left. Similarly, in a case where the movable body turns right, the second pendulum mechanism 14Ab moves (swings) the housing K in a turning outward direction (in the direction of the arrow M3b) together with the top plate member 12. As a result, it is possible to offset the influence of the centrifugal force at the time of the right turn. That is, it is possible to alleviate or suppress the stress applied to the living body when the movable body turns right.

In a case where the movable body turns simultaneously with acceleration or deceleration, the first pendulum mechanism 14Aa and the second pendulum mechanism 14Ab function simultaneously, so that it is possible to offset the influence of the inertial force in the front direction (the direction of the arrow F) or the back direction (the direction of the arrow B) and the centrifugal force in the right direction (the direction of the arrow R) or the left direction (the direction of the arrow L). That is, it is possible to alleviate or suppress the stress applied to the living body in the movable body.

Note that, in the description of FIGS. 1 to 5, an example has been described in which the living body transportation device 10 is fixed on the seat S of the movable body using the seat fixing body 16. In another embodiment, as described above, the living body transportation device 10 may be fixed on a trunk or the like using the belt attachment portion 14Cm, which is an example of the main body fixing portion 14C of the pendulum unit 14. Also in this case, it is possible to operate the living body transportation device 10 similarly to the case where the living body transportation device 10 is fixed on the seat S, and it is possible to offset the influence of the inertial force (including the centrifugal force) applied to the living body and to alleviate or suppress the stress applied to the living body.

As described above, the living body transportation device 10 of the present embodiment includes the top plate member 12 to and from which the housing K that can house a living body to be transported in a state of being in a movable body is attachable and detachable, and the pendulum unit 14 that includes the pendulum main body portion 14A that supports the top plate member 12 and performs a pendulum motion together with the top plate member 12 so as to suppress an inertial force acting on the living body during a moving motion accompanying at least one of an acceleration and deceleration motion and a turning motion with respect to a traveling direction of the movable body, the main body base portion 14B that supports the pendulum main body portion 14A, and the main body fixing portion 14C that is formed on the main body base portion 14B and enables the main body base portion 14B to be attachable and detachable to and from the movable body.

That is, a living body transportation device includes a top plate member to and from which a housing that can house a living body to be transported in a state of being in a movable body is attachable and detachable, and a pendulum unit that includes a pendulum main body portion that supports the top plate member and performs a pendulum motion together with the top plate member so as to suppress an inertial force acting on the living body during a moving motion accompanying at least one of an acceleration and deceleration motion and a turning motion with respect to a traveling direction of the movable body, a main body base portion that supports the pendulum main body portion, and a main body fixing portion that is formed on the main body base portion and enables the main body base portion to be attachable and detachable to and from the movable body.

According to this configuration, for example, the pendulum main body portion 14A moves (swings) the housing K in a direction based on the inertial force together with the top plate member 12 by the inertial force (the centrifugal force in the case of turning) accompanying the acceleration and deceleration or turning of the movable body. As a result, it is possible to offset the influence (the inertial force) of the acceleration and deceleration motion and the turning motion. That is, since the inertial force acting on the living body is suppressed using the pendulum motion at the time of acceleration and deceleration or turning of the movable body, the burden (the stress) on the living body at the time of transportation by the movable body can be reduced.

That is, according to the living body transportation device of the embodiment of the present disclosure, since the inertial force acting on the living body is suppressed using the pendulum motion at the time of acceleration and deceleration or turning of the movable body, the burden on the living body at the time of transportation by the movable body can be reduced.

(2) The living body transportation device 10 of the present embodiment may further include the seat fixing body 16 fixable to the seat S of the movable body, and the pendulum unit 14 may be attachable and detachable to and from the seat fixing body 16 via the main body fixing portion 14C.

That is, the living body transportation device further includes a seat fixing body fixable to a seat of the movable body, and the pendulum unit is attachable and detachable to and from the seat fixing body via the main body fixing portion.

According to this configuration, for example, the living body transportation device 10 can be easily attached to and detached from the seat S of the movable body, and the usability of the living body transportation device 10 can be further improved. In addition, the living body (a pet or the like) housed in the housing K can be easily put on the seat S, and it is possible to perform good transportation work for the protector of the living body (the pet owner or the like) and the living body (the pet or the like).

(3) Furthermore, the seat fixing body 16 of the living body transportation device 10 of the present embodiment may include the slide portion 16D as an adjustment mechanism that adjusts a fixed position of the pendulum unit 14 between a first fixed position when the pendulum unit 14 is attached to or detached from the seat fixing body 16 from an entrance side (a door side) of the seat S or when the housing K is attached to or detached from the top plate member 12 supported by the pendulum unit 14 attached to the seat fixing body 16 from the entrance side (the door side) and a second fixed position at which the pendulum unit 14 does not come into contact with a surrounding component when the pendulum unit 14 performs a pendulum motion.

That is, in the living body transportation device, the seat fixing body includes an adjustment mechanism that adjusts a fixed position of the pendulum unit between a first fixed position when the pendulum unit is attached to or detached from the seat fixing body from an entrance side of the seat or when the housing is attached to or detached from the top plate member supported by the pendulum unit attached to the seat fixing body from the entrance side and a second fixed position at which the pendulum unit does not come into contact with a surrounding component when the pendulum unit performs a pendulum motion.

According to this configuration, for example, by moving the seat fixing body 16 to the first fixed position using the adjustment mechanism (the slide portion 16D), it is possible to improve workability of attaching and detaching the living body transportation device 10 to and from the seat S and workability of attaching and detaching the housing K to and from the living body transportation device 10. In addition, by moving the seat fixing body 16 to the second fixed position using the adjustment mechanism (the slide portion 16D), it is possible to more satisfactorily alleviate or suppress the stress applied to the living body at the time of the turning motion of the movable body without the swing motion of the living body transportation device 10 coming into contact with the surrounding component (a door or the like) at the time of the movement of the movable body.

(4) Furthermore, the top plate member 12 of the living body transportation device 10 of the present embodiment may include a rotation mechanism (the rolling element 12r with a rotation lock mechanism) that can adjust a fixing direction of the housing K with respect to a traveling direction of the movable body.

That is, in the living body transportation device, the top plate member includes a rotation mechanism that can adjust a fixing direction of the housing with respect to a traveling direction of the movable body.

According to this configuration, for example, workability at the time of attaching and detaching the housing K to and from the top plate member 12 can be improved. In addition, it is possible to easily adjust the fixing direction of the housing K fixed to the top plate member 12 to a direction suitable for the movement of the movable body and to contribute to the relaxation of stress on the living body (the pet or the like).

Note that, the above embodiment has been described by exemplifying a relatively small living body such as a cat or a dog. However, for example, even in a case where a large living body such as livestock is transported on a truck bed or the like, by appropriately changing the size of the living body transportation device 10 based on the size of the living body (the size of the housing K), the technique of the present embodiment can be applied and similar effects can be obtained.

In the present embodiment, an example has been described in which the pendulum main body portion 14A is configured by a combination of the first pendulum mechanism 14Aa and the second pendulum mechanism 14Ab. In another embodiment, the pendulum main body portion 14A may be configured by either the first pendulum mechanism 14Aa or the second pendulum mechanism 14Ab for acceleration and deceleration or for turning.

Although the embodiments and modifications of the present disclosure have been described, these embodiments and modifications are presented as examples, and are not intended to limit the scope of the disclosure. These novel embodiments can be implemented in various other forms, and various omissions, substitutions, and changes can be made without departing from the gist of the disclosure. These embodiments and modifications thereof are included in the scope and gist of the disclosure, and are included in the disclosure described in the claims and the equivalent scope thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A living body transportation device comprising:
a top plate member to and from which a housing that can house a living body to be transported in a state of being in a movable body is attachable and detachable; and
a pendulum unit that includes a pendulum main body portion that supports the top plate member and performs a pendulum motion together with the top plate member so as to suppress an inertial force acting on the living body during a moving motion accompanying at least one of an acceleration and deceleration motion and a turning motion with respect to a traveling direction of the movable body, a main body base portion that supports the pendulum main body portion, and a main body fixing portion that is formed on the main body base portion and enables the main body base portion to be attachable and detachable to and from the movable body.

2. The living body transportation device according to claim 1, further comprising a seat fixing body fixable to a seat of the movable body, wherein
the pendulum unit is attachable and detachable to and from the seat fixing body via the main body fixing portion.

3. The living body transportation device according to claim 2, wherein
the seat fixing body includes an adjustment mechanism that adjusts a fixed position of the pendulum unit between a first fixed position when the pendulum unit is attached to or detached from the seat fixing body from an entrance side of the seat or when the housing is attached to or detached from the top plate member supported by the pendulum unit attached to the seat fixing body from the entrance side and a second fixed position at which the pendulum unit does not come into contact with a surrounding component when the pendulum unit performs a pendulum motion.

4. The living body transportation device according to claim 1, wherein
the top plate member includes a rotation mechanism that can adjust a fixing direction of the housing with respect to a traveling direction of the movable body.

5. The living body transportation device according to claim 2, wherein
the top plate member includes a rotation mechanism that can adjust a fixing direction of the housing with respect to a traveling direction of the movable body.

6. The living body transportation device according to claim 3, wherein
the top plate member includes a rotation mechanism that can adjust a fixing direction of the housing with respect to a traveling direction of the movable body.
